(19) United States
(12) Patent Application Publication
(10) Pub. No.: US 2011/0163579 A1
(43) Pub. Date: Jul. 7, 2011

(54) CHILD CAR SEAT COVER HAVING AN INTEGRATED TEMPERATURE MEASURING GAUGE

(76) Inventor: GREG WATSON, Davie, FL (US)

(21) Appl. No.: 12/683,627

(22) Filed: Jan. 7, 2010

(51) Int. Cl. B60N 2/60; B60N 2/44

(52) U.S. Cl. 297/188.01; 297/217.1

(57) ABSTRACT

A child car seat cover, the child car seat cover is made of insulating materials and has a temperature measuring gauge within the child car seat cover. The temperature measuring gauge measures the temperature of a child car seat prior to placing a child in the child car seat.

The present application is a continuation in part of U.S. patent application Ser. No. 12/191,005.

### BACKGROUND

The present invention is related to child car seat covers that allow users to determine the temperature of child car seats before placing a child in child car seats.

The inventor of the present invention knows that parents often place their children in child car seats that are burning hot. He knew that parents often attempted to control temperatures of the child car seats by covering the seats with insulating or non-insulating covers, yet this alone is not sufficient to prevent their children from getting burned, for temperatures within cars can become scalding hot.

The inventor of the present invention decided that he needed to give parents a tool that would prevent their children from getting burned when using child car seats.

The following are heat reflective seat cover patents or published applications: Samaha, U.S. Pat. No. 6,726,277 B1; Chai et al, U.S. Pat. No. 6,904,923 B2; Arenas, U.S. Pat. No. 6,659,551 B1; Sparks, U.S. Pat. No. 6,648,410; Franklin et al., U.S. Pat. No. 6,382,720 B1; Shikler, U.S. Pat. No. 5,655,810; Bernardo, U.S. Pat. No. 5,114,204; Busso et al., U.S. Pat. No. 4,790,592; Wilson, U.S. Pat. No. 4,458,738; Rieke, U.S. Pat. No. 4,118,066; Compton, Pub. No U.S. 2006/0284456 A1; Billock, Pub. No. U.S. 2007/0102079 A1; and Blackler, Pub. No. U.S. 2003/0057750 A1. All of the above referenced patents or applications pertain to attempts to insulate either automobile seats or child car seats with temporary seat covers. None of the above references provide a child car seat cover that allows a parent to gauge the temperature of the child car seat before placing a child in the child car seat.

An object of the present invention is to provide a user of a child car seat with a child car seat cover that would allow the user to check the temperature of the child car seat before placing a child in the child car seat.

Another object of the present invention is to provide a child car seat cover that will be easily placed over a child car seat.

For the foregoing reasons, there is a need for a child car seat cover that will measure the temperature of a child car seat prior to placing a child in a child car seat.

### SUMMARY

The present invention is directed to a child car seat cover that has a temperature measuring gauge within the child car seat cover that measures the temperature of the child car seat prior to placing a child in a child car seat.

The child car seat cover is comprised of an insulating sheet having a sleeve on its upper side and a temperature gauge that is attached to the bottom surface of the insulating sheet. The gauge takes the temperature of a child car seat while the child car seat cover is placed over the child car seat. The gauge is easily readable and provides a user with the ability to see what the temperature of the child car seat is prior to placing a child in the child car seat.

### DRAWINGS

These and other features, aspects, and advantages of the present invention will become better understood with regard to the following description, appended claims, and drawings where:

FIG. 1 shows a perspective view of a child car seat;

FIG. 2 shows a perspective view of one of the embodiments of the present invention;

FIG. 3 shows a top plan view of the insulating sheet of the present invention;

FIG. 4 shows a bottom plan view of the insulating sheet of the present invention; and

FIG. 5 shows a perspective view of another embodiment of the present invention.

### DESCRIPTION

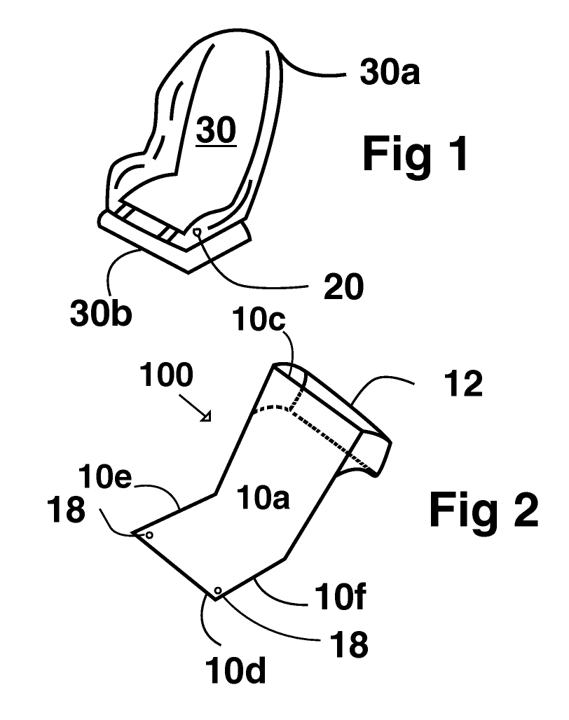

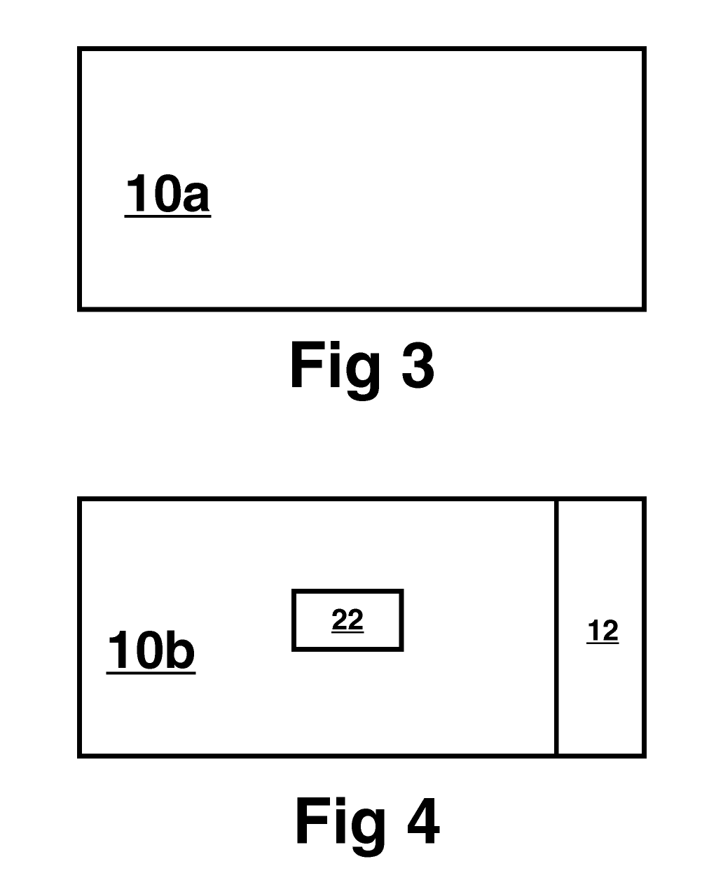

As seen in FIGS. 1-5, the child car seat cover of the present invention comprises of an insulating sheet 100 of material having a length and width to cover a child car seat 30. The insulating sheet 100 has a top 10a and bottom 10b surface, an upper 10c, a lower 10d, a left 10e, and a right 10f side, the upper side 10c of the insulating sheet defines a sleeve 12, and a temperature gauge 22, the gauge 22 is fixedly attached to the bottom surface 10b of the insulating sheet 100. The gauge 22 measures the temperature of a child car seat 30 when the child car seat cover is placed over the child car seat 30.

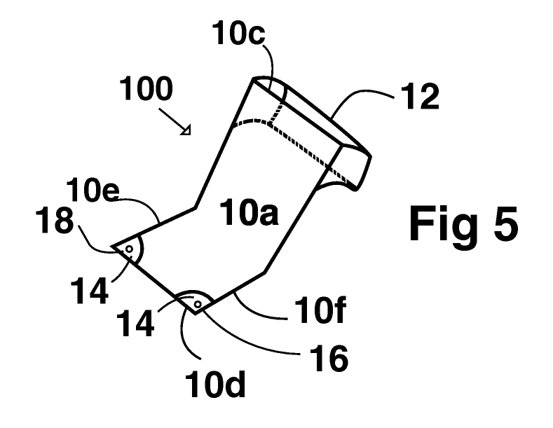

As seen in FIG. 5, in a further embodiment of the present invention, the child car seat cover might further comprise of a pair of pockets 14 and a pair of weighted objects 16. Each pocket 14 is attached to the insulating sheet 100 at positions adjacent to the left 10e/10d and right lower 10f/10d sides of the insulating 100 sheet and each weighted object 16 is housed within each pocket 14.

As seen in FIGS. 1-2, in another embodiment of the present invention, the child car seat cover might further comprise of a first set of magnets 18 having the same polarity, each first magnet 18 is fixedly attached to the insulating sheet 100 at positions adjacent to the left 10e/10d and right lower 10f/10d sides of the insulating sheet 100 and a second set of magnets 20 having an opposite polarity than the first set of magnets 18, the second set of magnets 20 are fixedly attached to a child car seat 30 at positions predetermined by a user of the child car seat cover, each second magnet 20 is attached to the child car seat 30 so that when the insulating sheet 100 is placed over the child car seat 30, the second set of magnets 20 line up with the first set of magnets 18 of the insulating sheet 100.

In some embodiments of the present invention, the insulating sheet 100 might be made of wool.

In other embodiments of the present invention, the insulating sheet 100 might be made of lightweight aluminized fiber.

The present invention is used as follows: 1. providing the child car seat cover; 2. providing a child car seat 30, the child car seat 30 having a head 30a and a leg section 30b; 3. placing the child car seat cover over the child car seat 30 so that the sleeve 12 is sleeved over the head section 30a of the child car seat 30; and 4. draping the rest of the child car seat cover over the child car seat 30.

An advantage of the present invention is that it provides a user of child car seat with child car seat cover that allows the user to check the temperature of child car seat before placing a child in the child car seat.

Another advantage of the present invention is that it provides child car seat covers that are easily placed over child car seats.

Although the present invention has been described in considerable detail with reference to certain preferred versions thereof, other versions are possible. Therefore the spirit and the scope of the claims should not be limited to the description of the preferred versions contained herein.

What is claimed is:

1. A child car seat cover that is placed over a car child seat, comprising:
an insulating sheet of material having a length and width to cover a child car seat, the insulating sheet has a top and a bottom surface, an upper, a lower, a left, and a right side, the upper side of the insulating sheet defines a sleeve; and
a temperature gauge that is fixedly attached to the bottom surface of the insulating sheet so that the gauge measures the temperature of a child car seat when the child car seat cover is placed over the child car seat.

2. The child car seat cover of claim 1, further comprising:
a pair of pockets, each pocket is attached to the insulating sheet at positions adjacent to the left and right lower sides of the insulating sheet; and
a pair of weighted objects, each weighted object is housed within each pocket.

3. The child car seat cover of claim 2, wherein the insulating material is made of wool.

4. The child car seat cover of claim 2, wherein the insulating material is made of a lightweight aluminized fiber.

5. The child car seat cover of claim 1, further comprising:
a first set of magnets having the same polarity, each magnet is fixedly attached to the insulating sheet at positions adjacent to the left and right lower sides of the insulating sheet; and
a second set of magnets having an opposite polarity than the first set of magnets, the second set of magnets are fixedly attached to a child car seat at positions predetermined by a user of the child car seat cover, each second magnet is attached to the child car seat so that when the insulating sheet is placed over the child car seat, the second set of magnets line up with the first set of magnets of the insulating sheet.

6. The child car seat cover of claim 5, wherein the insulating material is made of wool.

7. The child car seat cover of claim 5, wherein the insulating material is made of a lightweight aluminized fiber.

8. A method of using the child car seat cover of claim 2, comprising the steps of;
providing the child car seat cover of claim 1;
providing a child car seat, the child car seat having a head and a leg section;
placing the child car seat cover over the child car seat so that the sleeve is sleeved over the head section of the child car seat; and
draping the rest of the child car seat cover over the child car seat.
